(19) United States
(12) Patent Application Publication
(10) Pub. No.: US 2011/0154674 A1
(43) Pub. Date: Jun. 30, 2011

(54) PIPING ATTACHMENT FOR STEAM/CONDENSATE CONNECTIONS TO DT TRAYS

(76) Inventor: George E. Anderson, Champlin, MN (US)

(21) Appl. No.: 12/958,916

(22) Filed: Dec. 2, 2010

Related U.S. Application Data
(60) Provisional application No. 61/266,021, filed on Dec. 2, 2009.

(51) Int. Cl. F26B 19/00

(52) U.S. Cl. 34/60

(57) ABSTRACT

A desolventizer/toaster (DT). The DT in accordance with the present invention is provided with a generally circularly cylindrical body formed with respect to a generally vertically extending axis. A plurality of substantially planar panels, generally perpendicular to the axis with respect to which the body is formed define a plurality of axially aligned chambers. Means, proximate a wall defining the generally circularly cylindrical body, are provided to afford ingress and egress into one or more of the chambers.

### CROSS-REFERENCE TO RELATED APPLICATIONS

This is a regular application filed under 35 U.S.C. §111(a) claiming priority, under 35 U.S.C. §119(e) (1), of provisional application Ser. No. 61/266,021, previously filed Dec. 2, 2009 under 35 U.S.C. §111(b).

### TECHNICAL FIELD

The present invention deals broadly with the field of processing granular material having a solvent entrained therein. More narrowly, however, it deals with equipments for removing solvent from a granular material, such as edible grains, where the solvent has been used to separate one portion of the grain from another. The specific focus of the invention is the construction of a desolventizer-toaster (DT) which affords various advantages over such equipments known in the prior art.

### BACKGROUND OF THE INVENTION

Various solvents such as hexane, heptane and different alcohols are commonly used for treating granular solid materials to facilitate separation of one portion of the granular material from another. Typically, the solvents are used in processing of edible grains, in order to separate, for example, oil of the grain from the meal. Typical of this processing is the extraction of soybean oil from soybean grain.

The typical soybean oil-extraction process includes numerous steps. By way of example, included are cleaning, cracking, conditioning, expelling and solvent extraction. Performance of these steps results in an oil-depleted meal and a liquid oil. The oil can be further refined and processed for use in the making of consumer products such as margarine and shortening.

The oil seed meal, on the other hand, can be used as animal feed. It will be understood, of course, that the meal must be worked to remove residual solvent prior to being used for this purpose. After the extraction of oil and/or fat from the soybeans, some residual solvent remains entrained or entrapped within the solids. In order to maximize usage of the solids, it is imperative that as much of the residual solvent as possible be removed.

Traditionally, the solids are heated under a slight vacuum, and the solvent is effectively boiled from the meal. This process is known as desolventizing or desolventizing/toasting.

An apparatus referred to as a DT is known in the art and used to remove residual solvent from granular material. A DT commonly takes the form of a cylindrical chamber having mounted centrally therewithin a rotary shaft which drives multiple agitators or sweep arms. The agitators move over the bottom of each of a plurality of typically vertically stacked compartments. Frequently, an agitator is, in fact, spaced a slight distance from the bottom surface of the compartment within which the agitator moves. Such a construction serves to maintain adequate mixing motion of the meal and to keep the flakes as loose as possible.

The meal flakes pass through apertures typically distributed uniformly over the area of the bottom of the particular compartment. Such a construction serves to ensure substantially uniform distribution of live steam introduced through the bottom of the compartment. The compartment bottom, in such an equipment, can be defined by two plates which enclose a steam space connected to a supply of steam.

DT's such as that described hereinbefore typically have a number of shortcomings. Accessibility to the compartments of the DT from the outside of the equipment can be difficult. Repairs in various locations of the DT can, therefore, be difficult. Repairs to condensate and steam lines can be quite slow. With such prior art equipment, downtime can be significant.

Conventional DT piping frequently includes multiple bends and welds. This deters expeditious repairing of problems and, therefore, maximizes downtime.

The manufacture of a structure in accordance with the present invention facilitates isolation of locations where leaks might occur if an equipment in accordance with the invention is provided with a threaded connection for egress of steam condensate. This construction facilitates hydro-testing. Conceivably, all expansion stress-related failures could be moved outside of the vessel.

Because of proximity to the outer rim of a compartment, reduction of difficulty of alignment that has created problems with the packing gland can be accomplished.

It is to these shortcomings of the prior art and to the favorable characteristics provided that the present invention is directed. It is a piping attachment for steam and condensate connections to DT trays. More specific features and advantages obtained in view of those features will become apparent with reference to the further discussion herein and accompanying drawing figures.

### SUMMARY OF THE INVENTION

The present invention is a construction of a DT which facilitates introduction of live steam into chambers of the DT. The construction also facilitates egress of steam condensate from the chambers.

The invention comprises one or more attachments, which can be nipple-like in construction, each of which mates with one chamber port spaced angularly from the other ports in a DT chamber. The nipple-like construction renders the structure easily accessible. This is true because of the radially peripheral placement of the ports. The number of egress ports will vary depending upon the construction and application of the particular DT. Similarly, placement will vary depending upon the particular DT and its construction and application.

The invention is novel and unobvious in various contexts. It is viewed as a desolventizer/toaster (DT) which, as is the prior art structure illustrated in FIG. 1, includes a generally circularly cylindrical body. The body is defined by an enclosing wall which is formed along an axis. It is anticipated that the axis, during operation of the DT, will extend generally vertically. A plurality of substantially planar panels are mounted within the body wherein they are generally perpendicular to the axis. They do, thereby, define a plurality of axially extending chambers within the wall of the DT body. Means are provided to define a steam ingress/egress port which enters an interior of the body and communicates with a corresponding plenum. The steam ingress/egress port is provided at a location proximate the wall which forms the generally cylindrical body.

In a preferred embodiment, the port passed through the wall defining the body. As will be able to be seen, such a construction renders the interior of the generally cylindrical body more accessible than is the case with the prior art.

In a preferred construction of the invention, one or more of the axially aligned chambers are, in turn, subdivided into a plurality of circumferentially coextensive plenums. Barriers, extending generally from the axis with respect to which the generally circularly cylindrical body of the DT is formed, thereby define a plurality of circumferentially coextensive plenums.

The various embodiments and anticipated variations are shown in the accompanying drawing figures. The present invention is illustrated in the drawing figures accompanying this text.

### BRIEF DESCRIPTION OF THE DRAWINGS

FIG. 1 is a side elevational view, in section, of a DT type structure known in the prior art;

FIG. 2 is a portion of a DT structure in accordance with the present invention illustrating one embodiment for implementing the invention;

FIG. 3 is a portion of a DT structure in accordance with the present invention illustrating a second embodiment for implementing the invention; and

FIG. 4 is a portion of a DT structure in accordance with the present invention illustrating a third embodiment for implementing the invention.

### DETAILED DESCRIPTION OF THE INVENTION

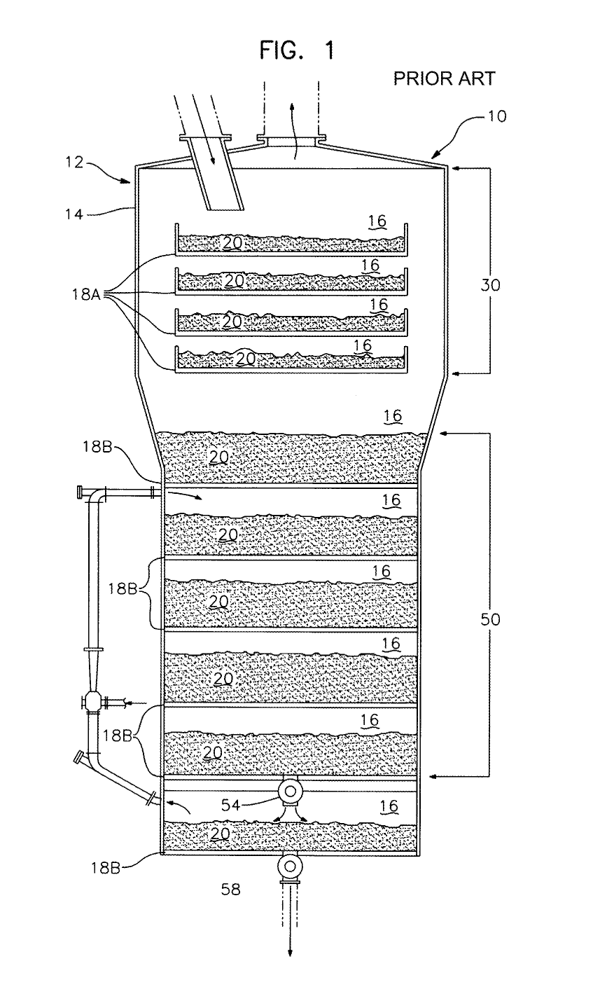

Referring now to the drawing figures, wherein like reference numerals denote like elements throughout the several views, FIG. 1 illustrates a desolventizer/toaster (DT) of the type to which the present invention is an improvement. A desolventizing apparatus 10 having a hollow, generally circularly cylindrical shaped housing 12 is shown. Housing 12 forms a vertical column 14 divided horizontally into a vertical series of compartments 16 by trays 18 for cascadingly carrying solvent-laden material 20. Each of the trays 18 has an opening through which the particulate material 20 is passed downwardly from one compartment to the next in a controlled manner. The column 14 can be equipped with agitation means, although such means are not illustrated. The agitation means, when used, maintain the particulate material occupying each tray in adequate mixing motion, to keep the particulate material in a loose, non-agglomerated and substantially homogeneous condition. Further, the agitation means moves the particulate material in a thin layer toward the tray outlets. Agitators or sweep arms can move over the bottoms of the compartments at a slight distance from the surface of the bottoms, and such structures are contemplated and may be powered by known drives and drive assemblies to affect horizontal or other suitable movement for the agitation means.

The vertical column 14 generally includes an upper indirect heating zone 30 and a lower direct heating zone 50. The upper indirect heating zone 30 includes five or less trays 18; four are shown in the drawing. In the upper indirect heating zone 30, the trays 18 are steam heated basket type trays which permits solvent vapors to flow around the trays at a low velocity and thereby minimize fines carried out of the column 14 with the solvent vapor. This provides a “clean” solvent vapor and thereby obviates the need for pretreatment prior to condensing of such solvent vapors.

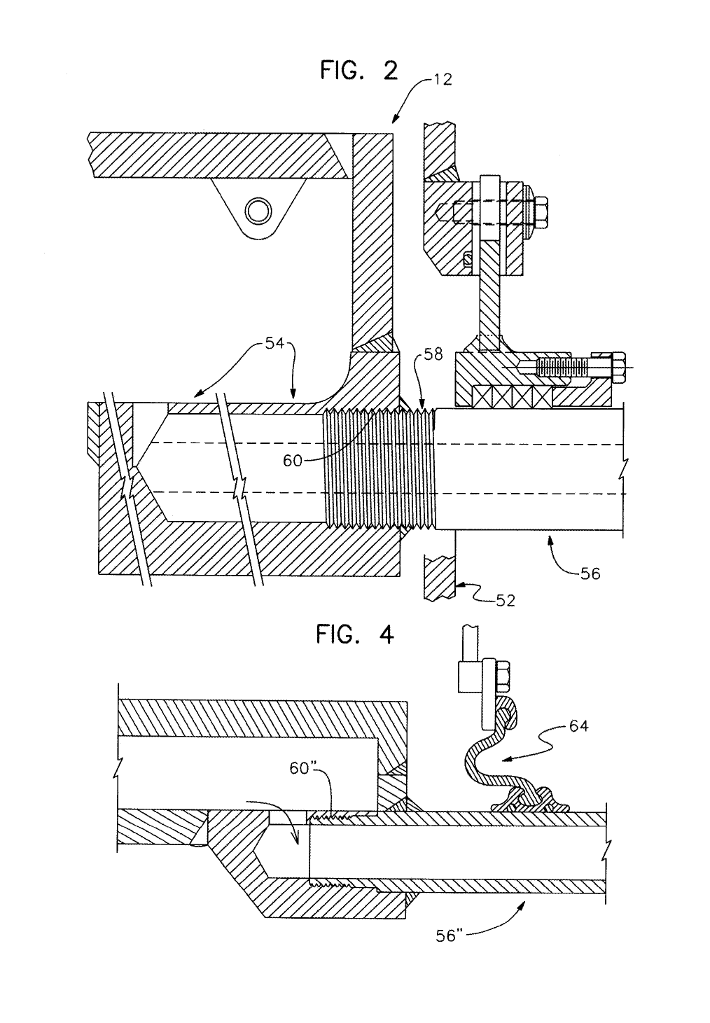

The DT illustrated in FIG. 1, however, can present problems as far as maintenance goes because of inaccessibility of the interior of the housing 12. FIGS. 2-4 illustrate various embodiments in accordance with the present invention which serve to afford access for maintenance and other purposes. As is seen in viewing FIG. 2, a portion of a wall 52 defining the DT body 12 is provided with a port 54 for attachment of a steam ingress/egress line 56. A nipple 58 is attached at the port 54 to afford fluid communication. The nipple 58 is attached to the wall 52 of the housing 12 by threaded means 60. As will be able to be seen in view of this disclosure, the internal chambers and plenums are readily accessible for maintenance and other purposes by removal of the nipple attachment.

FIG. 2 also illustrates supplemental attachment means for securing the steam ingress/egress conduit. The structure shown serves to effectively maintain the nipple 58 in its attachment mode without danger of inadvertent withdrawal.

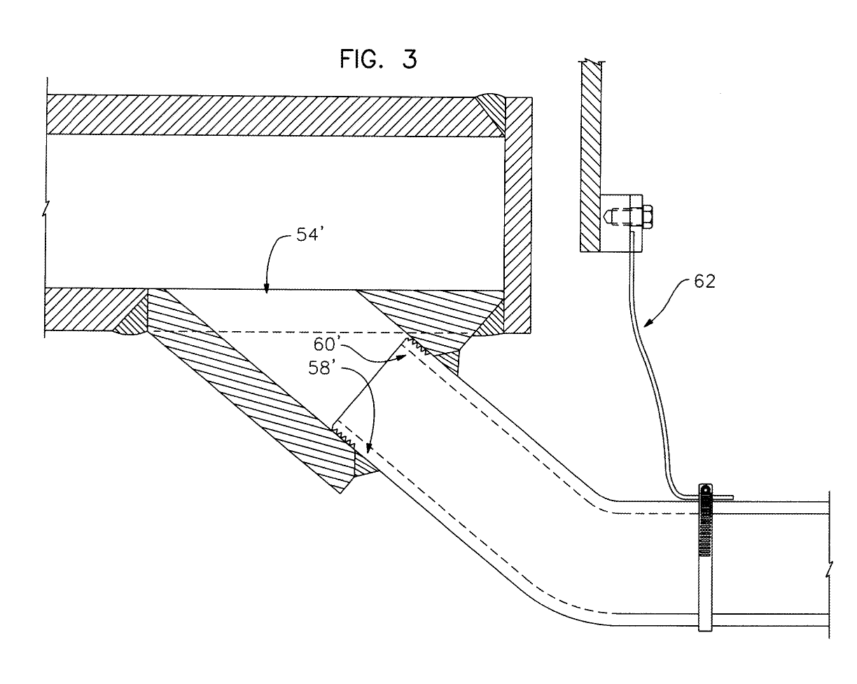

FIG. 3 shows a first alternative structure for placing a nipple attachment 58′ to afford communication through a port 54′ formed in the housing proximate the wall defining the housing. The conduit providing for steam ingress and egress is shown at an angle, although maintenance of attachment is accomplished by threaded means 60′. FIG. 3 also shows a spring securing means 62 to maintain the nipple 58′ in place and enable it to perform its assigned functions.

FIG. 4 also shows a nipple 58″ attached to the housing 12 at a location which, when the nipple 58″ is removed, affords accessibility to the interior of the housing 12. FIG. 4's embodiment also illustrates a structure for supplementing maintenance of the steam ingress/egress conduit in a securely maintained configuration, when such a configuration is desired. It comprises a spring-like mechanism 64 which accomplishes supplementing any threaded attachment.

The present invention does, therefore, employ a design which affords the ability to easily access the interior of the housing 12 from outside of the vessel. Such accessibility enables facile repair of condensate and steam lines. It also enables isolation of locations where leaks might take place contrary to conventional piping with multiple bends. Threaded connections allow for hydro-testing and also provides added barrier and pipe positioning for critical lock-pipe weld coseal.

Location of components at the peripheral rim reduces alignment difficulties. Such difficulties have, in the past, created problems with a packing gland.

The present invention is thus an improved DT apparatus. It will be understood that this disclosure, in many respects, is only illustrative. Changes may be made in details, particularly in matters of shape, size, material, and arrangement of parts without exceeding the scope of the invention. Accordingly, the scope of the invention is as defined in the language of the appended claims.

What is claimed is:

1. In a desolventizer/toaster (DT) having a generally circularly cylindrical body formed with respect to a generally vertically extending axis and a plurality of substantially planar panels, generally perpendicular to the axis, thereby defined by a plurality of axially aligned chambers, comprising:
means defining at least one steam ingress/egress port in each chamber, said port formed proximate a wall defining the generally cylindrical body.

2. The defining means of claim 1 wherein said ingress/egress port passes through said wall defining the generally cylindrical body.

3. The defining means of claim 1 wherein at least one chamber is subdivided into a plurality of circumferentially coextensive plenums by radially extending barriers.

4. A desolventizer/toaster (DT), comprising:
a generally circularly cylindrical body, defined by an enclosing wall, formed along an axis;
a plurality of substantially planar panels mounted within said body generally perpendicular to said axis to define a plurality of axially aligned chambers within said wall;
a plurality of barriers mounted inside each of said chambers and extending generally radially to define a plurality of circumferentially coextensive plenums; and
means defining at least one steam ingress/egress port entering an interior of said body and into a corresponding plenum.
